(19) United States
(12) Patent Application Publication
(10) Pub. No.: US 2022/0212959 A1
(43) Pub. Date: Jul. 7, 2022

(54) PLASMA AEROSOL HYBRID METHOD FOR FLUORO COMPOUND ABATEMENT

(71) Applicant: The Government of the United States of America, as represented by the Secretary of the Navy, Arlington, VA (US)

(72) Inventors: Swathi Iyer Ganjigunte Ramaswamy, Alexandria, VA (US); Manoj K. Kolel-Veetil, Annandale, VA (US)

(73) Assignee: The Government of the United States of America, as represented by the Secretary of the Navy, Arlington, VA (US)

(21) Appl. No.: 17/570,367

(22) Filed: Jan. 6, 2022

Related U.S. Application Data
(60) Provisional application No. 63/134,380, filed on Jan. 6, 2021.
(60) Provisional application No. 63/231,342, filed on Aug. 10, 2021.

(51) Int. Cl. C02F 1/30; C02F 1/46

(52) U.S. Cl. CPC C02F 1/30; C02F 2101/308; C02F 1/4608

(57) ABSTRACT

A method of: forming an aerosol of an aqueous liquid, and directing the aerosol into a plasma. The method can be used to degrade a polyfluoroalkyl substance.

This application claims the benefit of U.S. Provisional Application No. 63/134,380, filed on Jan. 6, 2021 and U.S. Provisional Application No. 63/231,342, filed on Aug. 10, 2021. The provisional applications and all other publications and patent documents referred to throughout this nonprovisional application are incorporated herein by reference.

### TECHNICAL FIELD

The present disclosure is generally related to the use of plasma for degradation of compounds.

### DESCRIPTION OF RELATED ART

The exceptional recalcitrance of the C—F bonds, the strongest carbon-containing organic bond, in fluorinated compounds such as polyfluoroalkyl substances (PFASs) has resulted in such chemicals being termed as “forever chemicals”. In recent decades, an impressive amount of research has been conducted towards the isolation, degradation, and destruction of these compounds. While such efforts span disparate capture media, and aqueous and non-aqueous catalytic reactions, an efficient and effective method that degrades PFASs still seems to be elusive. Especially, in the past few years, in addition to the widely studied catalytic processes such as persulfate oxidation, solvated electron reduction, thermal incineration, and biochemical degradation, new techniques such as sonochemical, microwave-hydrothermal, sub- and supercritical water-based and plasma-based processes are beginning to be explored for the destructions of PFASs. Among them, non-thermal plasma (NTP)-based approaches are most effective, cost-efficient and scalable, and are being pursued aggressively (Nzeribe et al., Physico-Chemical Processes for the Treatment of Per- And Polyfluoroalkyl Substances (PFAS): A review, Critical Reviews in Environmental Science and Technology, 49:10, 866-915 (2019)). Also, the added advantage of using NTP over other advanced oxidative processes is that it utilizes both oxidative and reductive processes.

NTP is a collection of free electrons, active and excited gas molecules, along with photons, emitted during de-excitation of excited gas molecules (Bruggeman et al., (2016), Plasma-Liquid Interactions: A Review and Roadmap, Plasma Sources Sci. Technol. 25 053002 (2016)). An important aspect of NTPs is that the momentum transfer between the light electrons and heavier particles, i.e. ions and neutral particles, are not efficient and a higher density of electrons can be created and maintained so that these electrons can be solvated further and can take part in reactions. The non-equilibrium in the thermal/kinetic energy of the fast moving free electrons relative to the almost static ions makes this class of plasma termed as low temperature plasma, that can be sustained with low energy input, minimum investment and smaller foot-print. The early stage atmospheric pressure plasma systems, governed by Paschen's rule, were primarily based on glow discharge, which used after-glow region chemistry (Torres et al., Paschen law for argon glow discharge, J. Phys.: Conf. Ser. 370 012067 (2012)). This fundamental understanding of utilizing the afterglow chemistry has paved way to approaches such as corona discharge for atmospheric pressure plasma application. Corona discharges, typically created due to dielectric breakdown of the gas between a conductor and electrode at extremely high voltages, are highly non-uniform but provide species similar to glow discharge plasma.

Recently, it was demonstrated that using reactive gases, such as 02, in DC plasma created both oxidative and reactive species substantially improving PFAS degradation efficiency (Yasuoka et al., An energy-efficient process for decomposing perfluorooctanoic and perfluorooctane sulfonic acids using DC plasmas generated within gas bubbles, Plasma Sources Science and Technology, 20(3), 034009 (2011); Takeuchi et al., Plasma-liquid interfacial reaction in decomposition of perfluoro surfactants. Journal of Physics D: Applied Physics, 47(4), 045203 (2014)). A similar pioneering effort (Lewis et al., Rapid degradation of PFAS in aqueous solutions by reverse vortex flow gliding arc plasma, Environ. Sci.: Water Res. Technol., 2020, 6, 1044-1057 (2020)) utilized a reverse vortex flow gliding arc plasma system that is submerged in PFAS contaminated water, where the interactions between circulating water and plasma species including oxygen radicals resulted in 75% PFAS removal, although the plasma power used, i.e. 255 W (918 kJ/L or 918 kWh/m³), was relatively higher than other plasma approaches. Further, a pilot-scale spark discharge plasma reactor setup has been used, where the short-lived corona streamers generated above the water interacted with Ar extending further the active radicals that were generated on contact with bubbling AFFF, which together with the streamers, initiated the PFOS/PFOA defragmentation (Lewis; Singh et al., Rapid Removal of Poly- and Perfluorinated Compounds from Investigation-Derived Waste (IDW) in a Pilot-Scale Plasma Reactor, Environ. Sci. Technol., 53, 19, 11375-11382 (2019)). Unlike other plasma techniques, the corona streamers produced with this method increased the water temperature; hence it became necessary to constantly recirculate water to avoid vaporization. This approach demonstrated 36-99% overall PFAS removal efficiency and the input energy (2-60 kWh/m³) required was one order lower than the glide arc plasma discharge approach. However, it is worth noting that other competing PFAS remediation approaches such as persulfate, photochemical oxidation, and sonolytic processes require ˜5000 kWh/m³ energy, which is 1-2 orders higher in comparison to that required by plasma-based approaches.

It has been established in general that the free electrons (e⁻) and the active radicals in the plasma interact with water at the interface to provide oxidative (OH*, O, H₂O₂, H₂O*, O₂⁻, O₃) and reductive species (solvated (e_{aq}⁻, H*, Ar⁺, Ar*). These highly reductive free electrons and solvated electrons have shown to influence the defluorination process of PFASs. The active free electrons, the solvated electrons, and Ar* radicals attack the —SOOH/COOH functional group of PFASs, initiating HF elimination reactions to subsequently reduce the PFASs. PFASs are predicted to undergo chain shortening processes via decarboxylation-hydroxylation-elimination-hydrolysis, by losing CO₂ or SO₂, etc., leading to defluorination. Furthermore, during such degradation/defluorination, elimination of —CF₂— groups from the evolving fluorocarbons can also be facilitated by such electrons (Singh; Bentel et al., Defluorination of Per- and Polyfluoroalkyl Substances (PFASs) with Hydrated Electrons: Structural Dependence and Implications to PFAS Remediation and Management, Environ. Sci. Technol, 53, 7, 3718-3728 (2019)). Length dependence has also been observed in the distinctive natures of the available degradation pathways when telomeric versions of PFASs are compared with their natural versions. Thus free electrons, the resultant solvated electrons, and H and OH radicals play a vital role in the PFAS/PFOS degradation process efficiency.

The energy of a typical free electron (1-3 eV) in atmospheric pressure plasma (APP), as expected, rapidly decreases as it moves away from the plasma zone and further declines as it reaches the water surface. Upon reaching the water surface, the still potent free electrons form activated water molecules and solvated electrons, whose energy is much lower than the free electrons. Until now most of the plasma remediation studies have focused on utilizing plasmas that are generated within the aqueous media or utilize non-uniform streamer near the water surface with Ar bubbling mechanism to increase the probability of PFAS and solvated electron (low energy and density) interactions. However, plasma creation within or near the aqueous surface limits the option to independently control the electron energy and density (plasma) and hence the solvated electrons.

### BRIEF SUMMARY

Disclosed herein is a method comprising: forming an aerosol of an aqueous liquid; and directing the aerosol into a plasma.

### BRIEF DESCRIPTION OF THE DRAWINGS

A more complete appreciation will be readily obtained by reference to the following Description of the Example Embodiments and the accompanying drawings.

FIG. 1 shows a schematic depiction of the hybrid plasma-aerosol system for PFASs remediation.

FIG. 2 shows a schematic depiction of the benefit of decreasing aerosol droplet size and creating micelles of PFASs to enhance plasma-PFAS interaction.

FIG. 3 shows representative PFAS compounds.

FIG. 4 shows additives found in a representative aqueous film forming foam (AFFF).

FIG. 5 shows a laboratory scale dielectric barrier discharge plasma system.

FIG. 6 shows degradation of Rhodamine R6G in water using air plasma.

FIG. 7 shows degradation of Rhodamine R6G in water using nitrogen plasma.

FIG. 8 shows degradation of Luminol in water using air plasma

FIG. 9 shows degradation of Luminol in water using nitrogen plasma

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a multiphase plasma aerosol hybrid technology for abatement in liquid of fluoro compounds, i.e. organic compounds containing multiple and diverse C—F bonds, Towards this, the effects of an independently generated plasma with tunable properties, i.e. electron energy and density, chemistry of the plasma radicals, and selective incorporation of reactive gases (O₂, H₂, N₂, NH₃, H₂O, etc.), are utilized to effect enhanced degradation of fluoro molecules within the aerosol droplets that are injected concentrically within the afterglow of the plasma for maximum plasma-aerosol interaction utilizing the free plasma electrons. Further, by engineering the aerosol droplet size from hundreds of microns to few nanometers, micelles of fluoro molecules will be formed generating specific effects on the fluoro molecule degradation efficiency. While typically ionic fluoro compounds in water provide the forward variety of micelles, alternatively by adding supercritical CO₂ (scCO₂) to such aqueous fluoro concentrates reverse micelles will be generated that will further improve the remediation efficiency.

The hybrid plasma processing system utilizes the after-glow region of a highly stable and tunable plasma, to which the PFAS contaminated water is injected concentrically in the form of aerosols. This enables direct in-flight reaction of highly energetic free electrons produced in the plasma after-glow region with PFAS that are contained in the water droplets. By engineering the droplet size (i.e. micrometers (normal droplets) vs. nanometers (micelles)), micelle variety (i.e. forward vs. reverse), plasma chemistry, and free electron properties, highly effective, low-footprint, energy-efficient, scalable and eco-friendly PFASs remediation can be achieved.

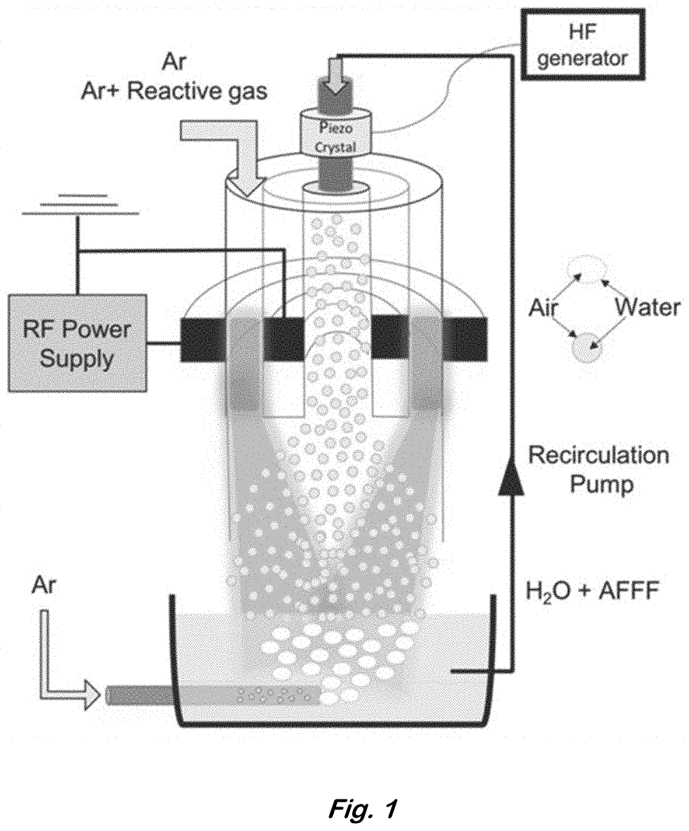

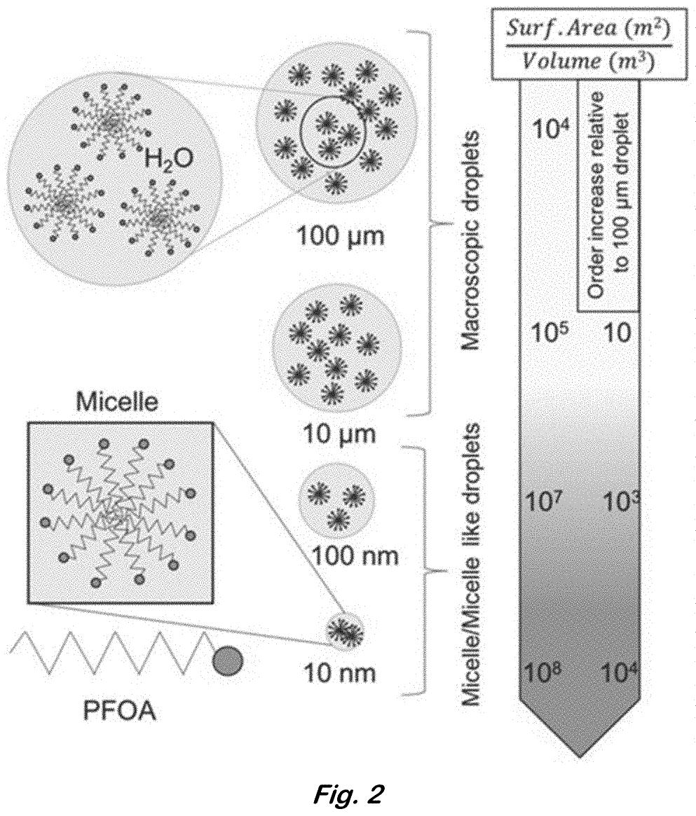

The plasma source may be any AC, DC, RF, DBD, glow discharge, or arc discharge plasma source. The plasma may be thermal or non-thermal, and the aerosol may be directed into the afterglow of the plasma. To control the inter-relation/changeability between the plasma properties, and its effect on aerosolized PFASs degradation, a lab-scale high frequency (13.56 MHz, capacitive coupling) plasma generator may be used that is concentrically integrated with an aerosol nozzle that can produce aerosols of varying sizes from microns to nanometers. A schematic depiction of such a set-up is presented in FIG. 1. While this design allows engineering the inter-electrode distance and the active plasma area to tune the electron energy and density, the chemistry of active species in the plasma may be controlled by using 1-2 vol. % of O₂, N₂, H₂, or H₂O. The microscopic properties of the plasma species is given by its I-V characteristics and can further be complemented with optical emission spectroscopic analysis of the plasma after-glow region. The nature of the micelles (FIG. 2) can be interrogated using dynamic light scattering and conductivity measurement techniques.

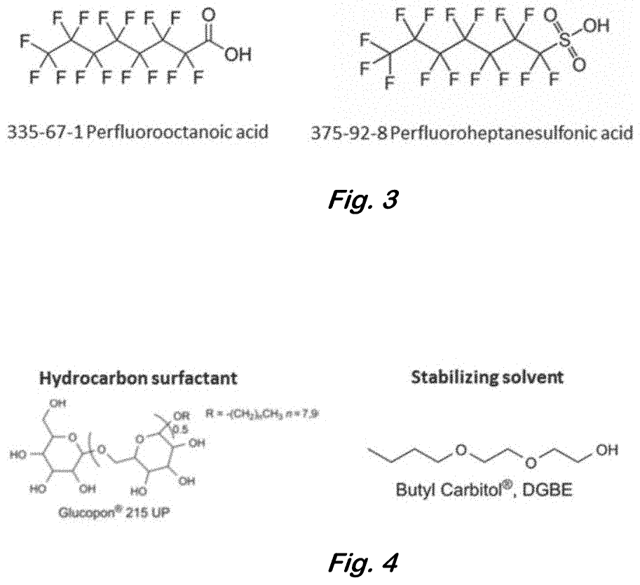

A recent formulation for an AFFF concentrate surrogate comprised 0.3% fluorocarbon surfactant concentrate, 0.2% hydrocarbon-surfactant concentrate and 0.5% diethylene glycol mono butyl ether (DGBE) (Hinnant et al., An Analytically Defined Fire-Suppressing Foam Formulation for Evaluation of Fluorosurfactant Replacement, J. Surfactants and Detergents, 21(5), 711-722 (2018)). However, for the 0.3% fluorocarbon surfactant, instead of using the fluorocarbon surfactant Capstone 1157, two representative PFAS molecules from Tables C44 and C45 of the EPA database, namely, perfluorooctanoic acid (PFOA), and perfluoroheptanesulfonic acid (PFAS/PFHeptS) are used (FIG. 3). Both have similar length for the fluorinated tail differing only in the head groups, namely, carboxylic and sulfonic and their anion versions, i.e. carboxylate and sulfonate, which are the most commonly found PFAS head groups. Glucopon® 215 UP and DGBE (FIG. 4) are used as the hydrocarbon surfactant and stabilizing solvent, respectively. In forming the micelles, each PFAS is investigated separately, and as their 50:50 mixture. In each case, the reactive species produced are be evaluated using spin trapping agents, such as for example, the cyclic nitrone, 5,5-dimethyl-1-pyrroline-1-oxide (DMPO) for detection of both hydroxyl and superoxide radicals (Turner et al., Spin Trapping of Superoxide and Hydroxyl Radicals with Substituted Pyrroline-1-Oxides, J. Med. Chem. 29 (12), 2439-2444 (1986)), and other appropriate agents for peroxide and other radicals. In addition, such studies are be performed in the presence or absence of the hydrocarbon surfactant and stabilizing solvent. To determine the efficiency of defluorination, the fluoride mass balance is evaluated using ion (F⁻ ion) selective electrodes (ISE) and the transformation products are characterized by liquid chromatography-high resolution mass spec (LC-HRMS) and other appropriate techniques. An in-depth study of the interaction of these two PFAS molecules, should provide a fundamental understanding of the hybrid plasma reaction chemistry, the science of which we can then be extended to the whole class of the twenty four PFAS molecules listed in Tables C44 and C45.

In general, PFAS molecules in aqueous media tend to form micelles due to hydrophobic groups and surface tension, where the terminal CF₃ functional groups are buried in the interior of the bubble. In droplets of larger size (100 micron), the probability of micelle formation is low, but by decreasing the droplet size to a few nm the probability of micelle formation can be greatly enhanced (Chen et al., Efficient Reductive Destruction of Perfluoroalkyl substances under Self-Assembled Micelle Confinement, Environ. Sci. Technol. 54, 5178-5185 (2020)). The benefit of this is that the electron affinitive —SO₃H or CO₂H and their anionic terminal functional groups of the PFASs can self-assemble on the surface of an evolving micelle to react rapidly with the fast approaching energetic, dense, free, and solvated electrons enabling rapid PFASs degradation compared to any other technology. An aerosolizer of any type, such as mechanical, piezoelectric, or ultrasonic, may be used to form the droplets. For example, piezoelectric nozzle(s) may be incorporated in the multiphase plasma aerosol reactor that can operate between 10 kHz to 2.4 MHz to create water droplet of varying sizes (100 μm to 10 nm). A criteria in selecting the ultrasonic nozzle is to ensure that it requires no carrier/secondary gas to transport the aerosols to the plasma but deliver directly into the plasma. Additionally, the low pressure created by the high velocity plasma gas in the concentric geometry will facilitate to draw the atomized droplets from the atomizer into the plasma through Venturi's effect/Bernoulli's principle.

While the AFFF concentrates in aqueous media with right aerosol engineering provide the forward micelles, scCO₂ addition to AFFF concentrates will produce reverse micelles, allowing the CF₃ terminal groups to be readily available at the surface (Wang et al., Solvation and Evolution Dynamics of an Excess Electron in Supercritical CO₂, Phys. Rev. Lett. 108, 207601-207605 (2012)). Though the CF₃ group is regarded as the most inert group to breakdown, the adjacent C—C bonds should be susceptible to rapid cleavage by the electrons and provide new routes of PFAS degradation than those seen with the attack of solvated electrons at the terminal —SO₃H or CO₂H and their anionic groups. Of course, the established degradation originating from the head groups can also proceed enabled by the portion of the electrons that traverse to the interiors of such reverse micelles. This simultaneous degradation from both head and tail is expected to degrade PFAS at much faster rates. In addition to all of the above efforts, the aerosol collection tank located at the bottom (FIG. 1) of the plasma-atomizer set up has an Ar diffuser to initiate bubbles within the AFFF aqueous solution. These PFAS-containing bubbles at the water surface encounter the still active free and solvated electrons and other reactive species that are remnant in the plasma stream, for further PFAS remediation.

The prior plasma based PFAS remediation approaches depend on the air bubble-plasma interface reactions, whereas the present approach exploits the water droplet-plasma interface reaction for PFASs remediation. The advantage of this approach is that the in-situ concentric injection of the aerosol droplets into the plasma enables direct contact with the energetic free electrons in the plasma and longer interaction time. In addition, engineering the aerosol droplet size to create the micelle provides value addition in PFASs remediation by increasing the surface area to volume ratio as depicted in the FIG. 2.

While the existing plasma technologies utilizing the non-uniform, streaky afterglow discharge have demonstrated 35-95% efficacy in PFAS remediation, the present aerosol-assisted plasma technology exploits both (i) uniform afterglow region with the “in-flight” PFAS-aerosol droplet (micelle)-plasma interaction and (ii) uniform afterglow plasma-PFAS-containing bubble interactions therefore serving as a combined dual/hybrid process with added advantage of substantially enhanced PFAS remediation efficiency than with the current plasma methods.

In arc-free glow discharge, maximum incident power is utilized for plasma generation and hence this approach requires less energy (electricity) and utilizes off-the-shelf components. These advantages in combination with aerosol formation, (increased surf. area/vol.) for enhanced reactions suggests a minimum of 50% reduction in cost/throughput relative to the current plasma processing (0.5$/L vs 0.25$/L).

The present method comprises forming an aerosol of an aqueous liquid and directing the aerosol into a non-thermal plasma. The liquid may be repeatedly processed by condensing the aerosol and recirculating the condensed aerosol to reform the aerosol.

The liquid may contain or be suspected of comprising a contaminant that is degraded by the plasma. Example contaminants include, but are not limited to, a polyfluoroalkyl substance, a perfluoroalkyl substance, perfluorooctanoic acid, an organic dye including linear, aliphatic, and aromatic dyes, Rhodamine (C₂₈H₃₁N₂O₃Cl), and Luminol (C₈H₇N₃O₂).

The droplets of the aerosol may have, for example, a diameter from 1 nm to 100 μm and may contain micelles or reverse micelles of the contaminant.

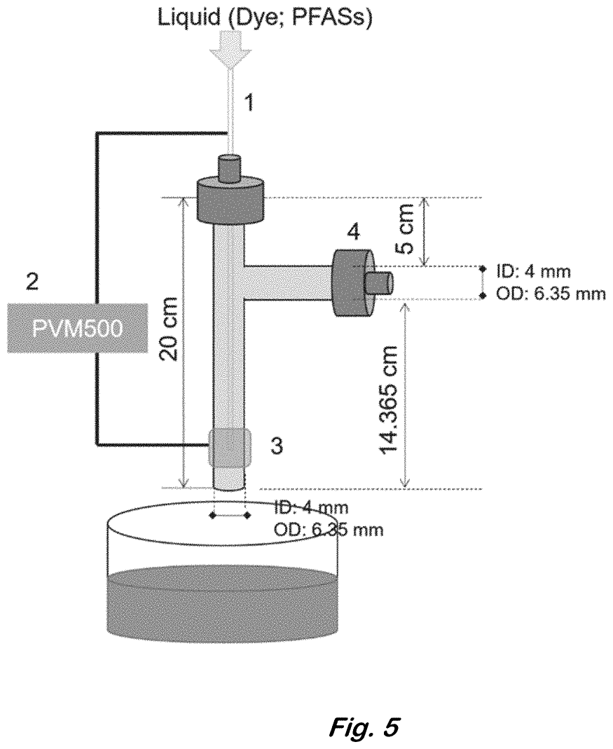

A laboratory scale dielectric barrier discharge plasma system was constructed for the destruction of organic dyes and PFASs that are dissolved in water. This plasma system consists of a 20 cm long quartz tube of 4 mm inner diameter and 6 mm outer diameters with a 5 cm long side port with the same ID/ODs that is about 14.365 cm from the bottom end of the 20 cm quartz tube (FIG. 5).

A hollow copper tube 1 (diameter=1.52 mm; length=25 cm), integrated into the quartz is fitted airtight (using Swagelok connectors). The hollow copper tube serves dual purpose as a high voltage dielectric enclosed electrode and also to transport the solvent into plasma afterglow. A 1 inch copper ring 3 fitted to the quartz tube at 5 mm from the bottom edge served as the ground electrode. The inner electrode was suspended in the head space region of the outer electrode such that it is 1 inch from the bottom edge. Dielectric barrier discharge plasma was generated between the outer and inner electrodes in the headspace using PVM500 power supply 2 (1-40 kV, 20-70 kHz). By tuning the applied voltage and frequency a stable discharge was obtained, which is characterized by a measurable output current and visually stable glow discharge that is only confined within the inner and outer electrode head space. In-house compressed nitrogen or air was used as the plasma gas for this scope of work and was adjusted to provide a stable flow of 20 SLM. The gas flow 4 in between the two concentric cylinders where the outer is quartz tube and the inner being the capillary copper tube that carries the solvent of interest. The solvent of interest is transported to the plasma using a peristaltic pump at 8.63 mL/min through the inner-most copper tube. The position of the inner electrode is aligned such that the reactive gas flow through the DBD micro-discharges before reaching the tip of inner copper tube where the solvent meets the high shear gas flow leading to atomization of the solvent. In addition to atomization, the gas also transports the active species that are created while traveling through the micro-discharges leading to plasma aerosolized solvent interaction in flight.

The organic materials of interest in this study were Rhodamine (R6G, C₂₈H₃₁N₂O₃Cl), Luminol (C₈H₇N₃O₂) and PFOA (C₈HF₁₅O₂) that were obtained from Sigma Aldrich and 3M respectively. A 5 (w/v) % solution was prepared by dissolving 5 mg of the solute in 500 mL of solvent, deionised (DI) water in the case of the dyes and fluoride-free DI water for PFOA respectively. The as-prepared solvent was injected at 10 mL/min rate through the inner copper tube as described above.

To evaluate the extent of the organic dye degradation, the change in characteristic UV-Vis light absorption of the dye was monitored. A UV-Vis spectrometer with 180 nm-900 nm spectral range was used. For the measurements, the solvent of interest was taken in a quartz cuvette, where DI water was used as the baseline and the untreated (pristine) solvent is used as the reference. On the other hand, PFASs do not have a characteristic optical absorbance so an ion selective electrode (ISE) technique was used to measure the extent of PFAS degradation, which detects free fluoride ions. The ISE relies on the complete degradation of the PFASs, i.e., complete destruction of the C—F bonds to generate free fluoride ions, which can be detected by fluorine selective conductivity. In general, high performance liquid chromatography (HPLC) is a powerful technique used to study degradation, but ionic and polar compounds pose a challenge and hence ion chromatography (IC) is the ideal technique for the separation and detection of ions and polar molecules. Since these techniques are highly sensitive even to a slight change in the molecular weight fractions of the PFASs, they don't rely on the complete PFAS degradation. Also, it should be emphasized that the United States Environment Protection Agency's (USEPA) health advisory concentration level (HAL) to be <70 ng/L, which does not require the complete destruction of the C—F bonds to generate free fluoride ions.

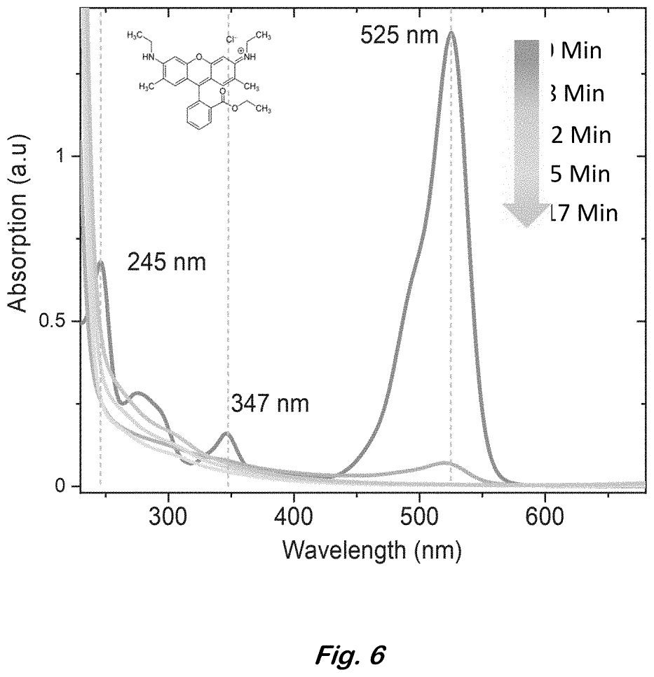

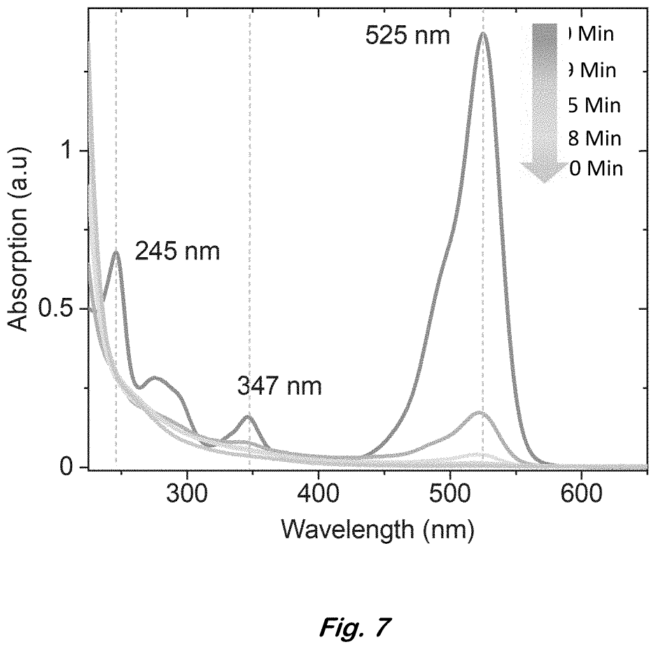

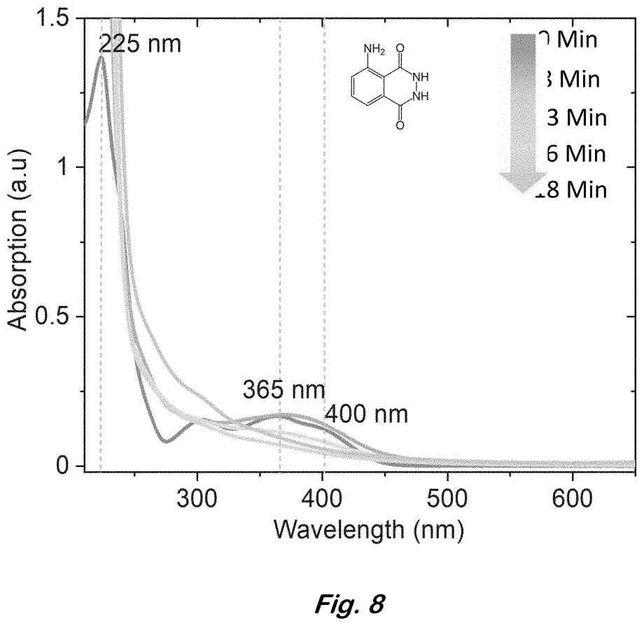

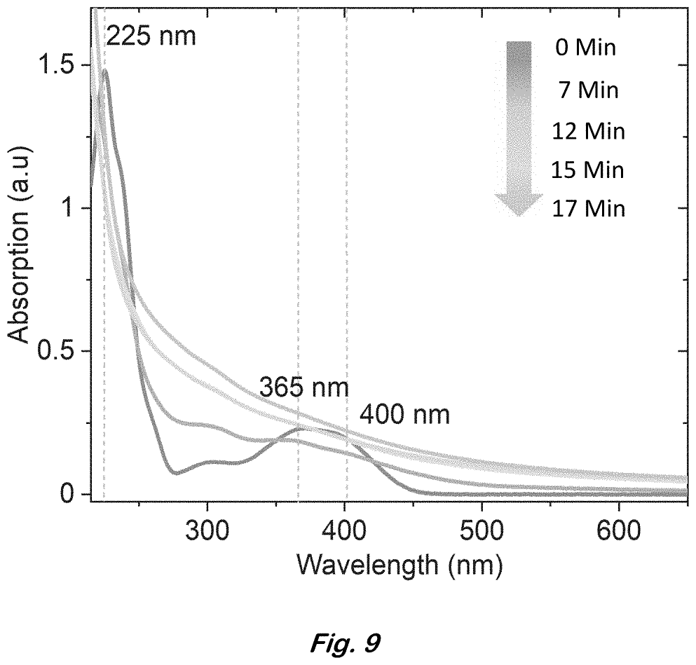

FIG. 6 shows degradation of Rhodamine R6G in water using air plasma. Complete degradation of the dye was achieved in less than 15 minutes. FIG. 7 shows that the degradation was somewhat less efficient using nitrogen plasma. Similar results are seen in FIGS. 8 and 9 for Luminol.

The table below shows that for PFOS, at single cycle (R1), with an exposure time of ˜1 second, degradation of C—F bond is seen.

| | | | | | un- | | |
|---|---|---|---|---|---|---|---|
| | | Po- | | diluted | diluted | | PFOA |
| | Dilution | tential | LOG | sample | sample | [F⁻] | De- |
| Sample | Factor | (mV) | C | (ppm) | (ppm) | (mM) | graded |
| V0 | 100 | 257.0 | −2.360 | 0.0044 | 0.44 | 0.023 | |
| Air V1 R1 | 100 | 216.0 | −1.639 | 0.0230 | 2.30 | 0.121 | 0.033% |
| Air V2 R2 | 100 | 191.2 | −1.202 | 0.0628 | 6.28 | 0.330 | 0.090% |
| Air V3 R3 | 100 | 181.1 | −1.025 | 0.0945 | 9.45 | 0.497 | 0.136% |

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A method comprising:
forming an aerosol of an aqueous liquid; and
directing the aerosol into a plasma.

2. The method of claim 1, wherein the aqueous liquid is suspected of comprising a contaminant that is degraded by the plasma.

3. The method of claim 2, wherein the contaminant is a polyfluoroalkyl substance.

4. The method of claim 2, wherein the contaminant is a perfluoroalkyl substance.

5. The method of claim 2, wherein the contaminant is perfluorooctanoic acid.

6. The method of claim 2, wherein the contaminant is an organic dye.

7. The method of claim 2, wherein the aerosol comprises droplets having a diameter from 1 nm to 100 μm.

8. The method of claim 7, wherein the droplets contain micelles of the contaminant.

9. The method of claim 7, wherein the droplets contain reverse micelles of the contaminant.

10. The method of claim 2, further comprising:
condensing the aerosol.

11. The method of claim 10, further comprising:
measuring the amount of the contaminant in the condensed aerosol.

12. The method of claim 10, further comprising:
recirculating the condensed aerosol to reform the aerosol.
